(19) United States
(12) Patent Application Publication
(10) Pub. No.: US 2013/0289146 A1
(43) Pub. Date: Oct. 31, 2013

(54) Foam Polystyrene-Based Bead and Method for Manufacturing the Same

(71) Applicant: Cheil Industries Inc., Gumi-si (KR)

(72) Inventors: Sang Hyuk KIM, Uiwang-si (KR); Il Jin KIM, Uiwang-si (KR); Yu Ho KIM, Uiwang-si (KR); Sa Eun CHO, Uiwang-si (KR); Kee Hae KWON, Uiwang-si (KR); Dong Hee KIM, Uiwang-si (KR); Seh Jin PARK, Uiwang-si (KR)

(21) Appl. No.: 13/927,532

(22) Filed: Jun. 26, 2013

Related U.S. Application Data
(63) Continuation-in-part of application No. PCT/KR2011/010094, filed on Dec. 26, 2011.

(30) Foreign Application Priority Data
Dec. 30, 2010 (KR) 10-2010-0138884
Dec. 30, 2010 (KR) 10-2010-0138886
Nov. 10, 2011 (KR) 10-2011-0117189
Nov. 18, 2011 (KR) 10-2011-0121141

(51) Int. Cl. C08J 9/16

(52) U.S. Cl. CPC C08J 9/16
USPC 521/59; 521/139

(57) ABSTRACT

The present invention relates to a foam polystyrene-based bead. The foam polystyrene-based bead includes: a core containing a styrene-based resin, a char-generating thermoplastic resin, and an expanded inorganic material; and a skin disposed on the surface of the core, wherein the skin contains a resin of which the glass transition temperature is below around 120° C. The foam is contained in the core or skin. The core may further include a carbon filler. Foam produced from the expandable polystyrene beads is not an inherently self-extinguishing flame retardant material yet can have good non-flammability comparable to or better than that of inherently flame retardant materials (Non flammability level 3) as measured in accordance with KS F ISO 5660-1, heat insulation properties, and mechanical properties.

### CROSS-REFERENCE TO RELATED APPLICATIONS

This application is a continuation-in-part of International Application No. PCT/KR2011/010094, filed Dec. 26, 2011, pending, which designates the U.S., published as WO 2012/091381, and is incorporated herein by reference in its entirety, and claims priority therefrom under 35 USC Section 120. This application also claims priority under 35 USC Section 119 to and the benefit of Korean Patent Application No. 10-2010-0138884, filed Dec. 30, 2010, Korean Patent Application No. 10-2010-0138886, filed Dec. 30, 2010, Korean Patent Application No. 10-2011-0117189, filed Nov. 10, 2011, and Korean Patent Application No. 10-2011-0121141, filed Nov. 18, 2011, the entire disclosure of each of which is incorporated herein by reference.

### FIELD OF THE INVENTION

The present invention relates to expandable polystyrene beads and a method for preparing the same.

### BACKGROUND OF THE INVENTION

Generally, foam molded articles of expandable polystyrene can exhibit high strength, light weight, buffering, waterproofing, heat retention and thermal insulation properties and thus are used as packaging materials for home appliances, boxes for agricultural and fishery products, buoys, thermal insulation materials for buildings and the like. Seventy percent or more of domestic demand for expandable polystyrene is for use as thermal insulation materials for buildings or as cores of sandwich panels.

However, in recent years, the use of such expandable polystyrenes has been restricted since they are being blamed for fires. Thus, in order for the expandable polystyrenes to be used as thermal insulation materials for buildings and the like, it is necessary for the expandable polystyrenes to have a predetermined level of non-flammability for thermal insulation materials for buildings.

Korean Patent No. 0602205 discloses a method for producing non-flammable pre-expanded polystyrene beads by coating expanded graphite, a thermosetting resin and a curing catalyst onto expandable polystyrene beads and curing the resultant coated beads.

Korean Patent No. 0602196 discloses a method for producing non-flammable pre-expanded polystyrene beads, which includes coating a metal hydroxide compound selected from the group consisting of aluminum hydroxide (Al(OH)₃), magnesium hydroxide (Mg(OH)₂) and mixtures thereof, a thermosetting liquid phenolic resin, and a curing catalyst for the phenolic resin onto expandable polystyrene beads and crosslinking the resultant coated beads.

In these patents, the surfaces of expandable beads are crosslinked with a thermosetting resin, which inhibits secondary foaming of the beads by steam. Accordingly, these methods can decrease strength and fusion between particles in the course of manufacturing molded articles (panels). Furthermore, these methods can cause environmental pollution due to the use of thermosetting resins, such as phenolic resin, melamine resin, and the like; they can require additional facility investment to coat thermosetting resins or inorganic materials; and they can cause deterioration in physical properties of resins due to the use of the inorganic materials.

Therefore, there is a need for a method of making an expandable polystyrene resin without causing deterioration of fusion and strength between particles while preventing environmental pollution in the course of manufacturing molded articles.

### SUMMARY OF THE INVENTION

The present invention provides expandable polystyrene beads, which may not have inherently self-extinguishing flame retardancy properties yet can have good non-flammability (that is can have good flame retardancy), for example, can have a flame retardancy that is comparable to or better that the flame retardancy of inherently flame retardant materials measured in accordance with KS F ISO 5660-1, and a method for manufacturing the same. The expandable polystyrene beads further can exhibit good non-flammability (flame retardancy), thermal insulation and excellent mechanical strength and can be manufactured with minimal facility investment and with minimal or no environmental pollution. Still further, the expandable polystyrene beads can have good processability. In addition, the expandable polystyrene beads can have an increased content of carbon particles and may not require a separate screening step. The expandable polystyrene beads also can be manufactured having a desired size at a high yield.

The present invention also provides flame retardant polystyrene foam produced using the expandable polystyrene beads. The flame retardant polystyrene foam produced using the expandable polystyrene beads can have an outstanding balance of physical properties such as non-flammability, thermal conductivity and mechanical strength and can be suitable for a sandwich panel.

The above and other aspects can be accomplished by the present invention described in detail in the following.

The present invention relates to expandable polystyrene beads. The expandable polystyrene beads may include: a core including a styrene resin, a char-generating thermoplastic resin, and expanded inorganic material; and a skin formed on a surface of the core and containing a resin having a glass transition temperature of about 120° C. or less, for example a styrene resin having a glass transition temperature of about 120° C. or less, wherein the core and/or the skin contains a foaming agent.

The core may further include carbon fillers. Examples of the carbon fillers may include without limitation graphite, carbon black, carbon fibers, carbon nanotubes, and the like, and combinations thereof.

The carbon fillers may have an average particle diameter of about 0.1 μm to about 100 μm.

The skin may be free from the expanded inorganic material and/or the carbon fillers.

The skin may surround a portion or the entirety of a surface of the core.

The expandable polystyrene beads may have a surface composed of a resin having a glass transition temperature of about 120° C. or less and a foaming agent impregnated into the resin, and may be free from the char-generating thermoplastic resin and/and the expanded inorganic material.

The styrene resin and the char-generating thermoplastic resin may be present in a ratio of about 90 to about 99 wt %:about 1 to about 10 wt %.

The styrene resin may have a weight average molecular weight of about 180,000 g/mol to about 300,000 g/mol.

The char-generating thermoplastic resin may have an oxygen bond, an aromatic group or a combination thereof in a backbone thereof.

Examples of the char-generating thermoplastic resin may include without limitation polycarbonates, polyphenylene ethers, polyurethanes, polyphenylene sulfides, polyesters, polyimide resins, and the like, and combinations thereof.

The expanded inorganic material may include without limitation expanded graphite, silicate, perlite, white sand, and the like, and combinations thereof.

The expanded inorganic material may have an average particle diameter of about 170 μm to about 1,000 μm, and may have an expansion temperature of about 150° C. or more.

Examples of the styrene resin having a glass transition temperature of about 120° C. or less may include without limitation general purpose polystyrene (GPPS) resins, high impact polystyrene (HIPS) resins, acrylonitrile-butadiene-styrene (ABS) copolymers, styrene-acrylonitrile (SAN) copolymers, styrene-methyl methacrylate copolymers, and the like, and combinations thereof.

The expandable polystyrene beads may further include at least one additive selected from antiblocking agents, nucleating agents, antioxidants, carbon particles, fillers, antistatic agents, plasticizers, pigments, dyes, heat stabilizers, UV absorbers, flame retardants, and the like, and combinations thereof.

A ratio of core radius to skin thickness may range from about 1:0.0001 to about 1:0.2.

The expandable polystyrene beads may have an average particle diameter of about 0.5 mm to about 5 mm.

A weight ratio of the core to the skin may range from about 1:0.035 to about 1:0.23.

The present invention also relates to a non-flammable polystyrene foam. The foam may be formed by foaming the expandable polystyrene beads, and may have a total heat release (THR) of about 0.9 MJ/m² or less, as measured after heating a 50 mm thick sample at 50 kW/m² using a cone heater for five minutes in accordance with KS F ISO 5560-1, a compressive strength of about 19 N/cm² or more in accordance with KS M 3808, and a degree of fusion of about 20% to about 60%.

The present invention further relates to a method for manufacturing non-flammable expandable polystyrene beads. The method may include preparing a core including a styrene resin, a char-generating thermoplastic resin, and expanded inorganic material; and forming a skin on a surface of the core through polymerization by adding a monomer having a glass transition temperature of about 120° C. or less to the core.

In one embodiment, the core may be prepared by extruding a mixture of the styrene resin, the char-generating thermoplastic resin and the expanded inorganic material.

In another embodiment, the core may be prepared by adding carbon fillers to a mixture of the styrene resin, the char-generating thermoplastic resin and the expanded inorganic material, followed by extruding the mixture.

In a further embodiment, the core may be prepared by polymerizing a mixture of the styrene monomer, the char-generating thermoplastic resin and the expanded inorganic material.

In a further embodiment, the core may be prepared by adding carbon fillers to a mixture of the styrene monomer, the char-generating thermoplastic resin and the expanded inorganic material, followed by polymerizing the mixture.

The step of forming a skin may include adding about 5 parts by weight to about 30 parts by weight of a monomer having a glass transition temperature of about 120° C. or less to about 100 parts by weight of the core for the polymerization.

The step of forming a skin may include adding a foaming agent before, during and/or after polymerization.

The step of forming a skin may include adding at least one of antiblocking agents, nucleating agents, antioxidants, carbon particles, fillers, antistatic agents, plasticizers, pigments, dyes, heat stabilizers, UV absorbers, flame retardants, peroxide initiators, suspension stabilizers, foaming agents, chain transfer agents, and expansion aids, when polymerizing by adding the monomer having a glass transition temperature of about 120° C. or less.

The present invention provides expandable polystyrene beads, which are not formed of an inherently self-extinguishing flame retardant material yet can have good non-flammability (flame retardancy) comparable to or greater than that of inherently flame retardant materials as determined in accordance with KS F ISO 5660-1, may be produced at high yield without additional processes, can exhibit good non-flammability, thermal insulation and excellent mechanical strength, may not cause environmental pollution, are capable of being manufactured with little facility investment, can have good processability, can permit easy size adjustment, and can increase carbon particle percentage. The present invention also provides a method for manufacturing the same. In addition, the present invention provides non-flammable polystyrene foam produced using the expandable polystyrene beads, which can have an outstanding balance of physical properties such as non-flammability, thermal conductivity and/or mechanical strength and can be suitable for construction materials such as sandwich panels.

### DESCRIPTION OF THE DRAWINGS

FIG. 1 is a schematic cross-sectional view of an expandable polystyrene bead in accordance with one embodiment of the present invention.

FIG. 2 is a schematic cross-sectional view of an expandable polystyrene bead in accordance with another embodiment of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Expandable polystyrene beads include: a core including a styrene resin, a char-generating thermoplastic resin and expanded inorganic material; and a skin formed on a surface of the core and including a resin having a glass transition temperature of about 120° C. or less, wherein the core and/or the skin contains a foaming agent. The skin may be free from the expanded inorganic material.

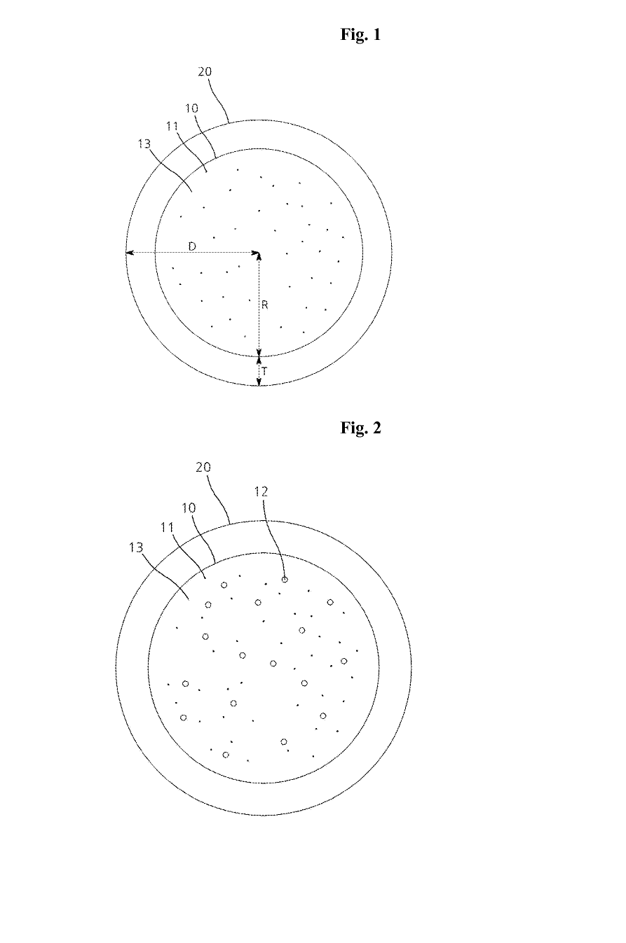

FIG. 1 is a schematic cross-sectional view of an expandable polystyrene bead in accordance with one embodiment of the invention. As shown, the expandable polystyrene beads include a core 10; and a skin 20 surrounding a surface of the core.

Core

Referring again to FIG. 1, the core includes expanded inorganic material 11 dispersed in a mixed resin 13 of a styrene resin and a char-generating thermoplastic resin. In the mixed resin 13, the styrene resin and the char-generating thermoplastic resin are uniformly mixed to form a continuous phase.

In some embodiments, the styrene resin and the char-generating thermoplastic resin may be mixed in a weight ratio of about 90 to about 99 wt %:about 1 to about 10 wt % in the mixed resin 13.

In some embodiments, the mixed resin including the styrene resin and the char-generating thermoplastic resin may include the styrene resin in an amount of about 90, 91, 92, 93, 94, 95, 96, 97, 98, or 99 wt %. Further, according to some embodiments of the present invention, the amount of the styrene resin can be in a range from about any of the foregoing amounts to about any other of the foregoing amounts.

In some embodiments, the mixed resin including the styrene resin and the char-generating thermoplastic resin may include the char-generating thermoplastic resin in an amount of about 1, 2, 3, 4, 5, 6, 7, 8, 9, or 10 wt %. Further, according to some embodiments of the present invention, the amount of the char-generating thermoplastic resin can be in a range from about any of the foregoing amounts to about any other of the foregoing amounts.

In exemplary embodiments, the styrene resin may be a homopolymer of styrene monomers, a copolymer of a styrene monomer and a copolymerizable monomer, or a mixture thereof. In another embodiment, the styrene resin may be a mixture of a styrene resin and other resins

In one embodiment, the styrene resin may have a weight average molecular weight of about 180,000 g/mol to about 300,000 g/mol. Within this range, the styrene resin can provide good processability and mechanical strength to thermal insulation materials formed of the styrene resin.

Examples of the styrene resin may include without limitation general purpose polystyrene (GPPS) resins, high impact polystyrene (HIPS) resins, copolymers of styrene monomers and α-methylstyrene, acrylonitrile-butadiene-styrene (ABS) copolymers, styrene-acrylonitrile (SAN) copolymers, styrene-methyl methacrylate copolymers, blends of styrene resins and polymethyl methacrylate, and the like. These may be used alone or in combination of two or more thereof. In exemplary embodiments, general purpose polystyrene (GPPS) and/or high impact polystyrene (HIPS) resins can be used.

The char-generating thermoplastic resin may have an oxygen bond, an aromatic group, or both an oxygen bond and an aromatic group, in a backbone thereof.

Examples of the char-generating thermoplastic resin may include without limitation polycarbonates, polyphenylene ethers, polyurethane resins, and the like. These may be used alone or in combination of two or more thereof. In another embodiment, polyesters such as polyethylene terephthalate (PET), polybutylene terephthalate (PBT), and the like, polyphenylene sulfides (PPS), polyimides, and the like may also be used. These resins may be used alone or in combination of two or more thereof.

In one embodiment, the polycarbonate resin may have a weight average molecular weight of about 10,000 g/mol to about 30,000 g/mol, for example about 15,000 g/mol to about 25,000 g/mol.

Examples of the polyphenylene ether may include without limitation poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, copolymers of poly(2,6-dimethyl-1,4-phenylene)ether and poly(2,3,6-trimethyl-1,4-phenylene)ether, copolymers of poly(2,6-dimethyl-1,4-phenylene)ether and poly(2,3,5-triethyl-1,4-phenylene)ether, and the like, and combinations thereof. In exemplary embodiments, a copolymer of poly(2,6-dimethyl-1,4-phenylene)ether and poly(2,3,6-trimethyl-1,4-phenylene)ether and/or poly(2,6-dimethyl-1,4-phenylene)ether can be used, for example, poly(2,6-dimethyl-1,4-phenylene)ether can be used.

The polyphenylene ether may have an intrinsic viscosity of about 0.2 dl/g to about 0.8 dl/g as measured in a chloroform solution at 25° C., to have good thermal stability and workability.

Due to high glass transition temperature, the polyphenylene ether may provide much higher thermal stability when mixed with the styrene resin, and may be mixed with the styrene resin in any ratio.

The thermoplastic polyurethane resin may be prepared by reacting diisocyanate with a diol compound, and may include a chain transfer agent, as needed. Examples of diisocyanates include without limitation aromatic, aliphatic and/or alicyclic diisocyanate compounds. Examples of diisocyanates may include without limitation 2,4-tolylene diisocyanate, 2,6-tolylene diisocyanate, phenylene diisocyanate, 4,4′-diphenyl methane diisocyanate, 4,4′-diphenyl diphenyl diisocyanate, 1,5-naphthalene diisocyanate, 3,3′-dimethylbiphenyl-4,4′-diisocyanate, o-, m- or p-xylene diisocyanate, tetramethylene diisocyanate, hexamethylene diisocyanate, trimethyl hexamethylene diisocyanate, dodecanemethylene diisocyanate, cyclohexane diisocyanate, dicyclohexylmethane diisocyanate, and the like, and combinations thereof.

Examples of diol compounds may include without limitation polyester diols, polycaprolactone diols, polyether diols, polycarbonate diols, and the like, and mixtures thereof. For example, mention can be made of ethylene glycol, 1,2-propylene glycol, 1,3-propylene glycol, butane 1,2-diol, butane 1,3-diol, butane 1,4-diol, butane 2,3-diol, butane 2,4-diol, hexane diol, trimethylene glycol, tetramethylene glycol, hexene glycol and propylene glycol, polytetramethylene ether glycol, dihydroxy polyethylene adipate, polyethylene glycol, polypropylene glycol, and the like, and combinations thereof, without being limited thereto.

In the present invention, the char-generating thermoplastic resin may be present in an amount of about 1 wt % to about 10 wt % in the mixed resin 13. Within this range, the composition can obtain excellent non-flammability and mechanical strength.

The expanded inorganic material 11 may have a particle shape. Examples of the expanded inorganic material may include without limitation expanded graphite, silicate, perlite, white sand, and the like. These may be used alone or in combination of two or more thereof.

In the present invention, the expanded inorganic material may act as char formers. Accordingly, it is necessary for the expanded inorganic material to maintain their shape without collapsing upon melt extrusion with resins and to have a uniform size in order to provide non-flammability, mechanical strength, and thermal conductivity.

In one embodiment, the expanded inorganic material may have an average particle diameter of about 170 μm to about 1,000 μm. Within this range, the expanded inorganic material can act as char formers, thereby obtaining desired non-flammability, mechanical strength, and thermal conductivity. The expanded inorganic material can have a particle diameter of about 200 μm to about 750 μm, and as another example about 300 μm to about 650 μm.

The expanded graphite may be prepared by inserting chemical species capable of being inserted into interlayers into layered crystal structures of graphite and subsequently subjecting the same to heat or microwave. In one embodiment, the expanded graphite may be prepared by treating graphite with an oxidizing agent to introduce chemical species, such as SO₃²⁻ and NO³⁻, between the graphite layers in order to form interlayered compounds, rapidly subjecting the graphite having the interlayered compounds to heat or microwave in order to gasify the chemical species bonded between the interlayers, and then expanding the graphite hundreds to thousands of times by pressure resulting from gasification. Those expanded inorganic material particles can be commercially available ones.

In the present invention, expanded graphite expanding at about 150° C. or more can be used. When the expanded graphite subjected to expansion at about 150° C. or more is used, it can be expected that the expanded graphite particles act as char formers by minimizing deformation or collapse upon melt extrusion with resins. The expanded graphite can expand, for example, at about 200° C. or more, as another example at about 250° C. or more, and as yet another example at about 300° C. or more. In one embodiment, the expanded graphite has an expansion temperature from about 200° C. to about 700° C.

The silicates may be organically modified layered silicates, and can include without limitation sodium silicate, lithium silicate, and the like, and combinations thereof. In the present invention, the silicate may generate char to form a blocking membrane, thereby maximizing non-flammability. Clays such as smectites, kaolinites, illites, and the like may be organically modified and used as organically modified layered silicates. Examples of clays may include without limitation montmorillonites, hectorites, saponites, vermiculites, kaolinites, hydromicas, and the like, and combinations thereof. As a modifying agent for organizing the clays, alkylamine salts and/or organic phosphates may be used. Examples of alkylamine salts may include without limitation didodecyl ammonium salt, tridodecyl ammonium salt, and the like, and combinations thereof. Examples of organic phosphates may include without limitation tetrabutyl phosphate, tetraphenyl phosphate, triphenyl hexadecyl phosphate, hexadecyl tributyl phosphate, methyl triphenyl phosphate, ethyl triphenyl phosphate, and the like, and combinations thereof. The alkylamine salts and/or organic phosphates may be substituted with interlayered metal ions of layered silicates to broaden the interlayer distance, thereby providing layered silicates compatible with organic materials and capable of being kneaded with resins.

In one embodiment, montmorillonite modified by a C₁₂-C₂₀ alkyl amine salt may be used as the organically modified layered silicate. In some embodiments, the organically modified montmorillonite (hereinafter referred to as “m-MMT”) may be organized with dimethyl dehydrogenated tallow ammonium at interlayers thereof, instead of Na+.

The perlite may be heat-treated expanded perlite. The expanded perlite may be prepared by heating perlite at a temperature of about 870 to about 1100° C. to vaporize volatile components including moisture together with generation of vaporizing pressure, causing expansion of each granule by about 10 to about 20 times to form round, glassy particles.

In one embodiment, the expanded perlite may have a specific gravity of about 0.04 g/cm² to about 0.2 g/cm².

The white sand particles may be expanded white sand particles.

In the present invention, the expanded inorganic material may be added in an amount of about 3 parts by weight to about 50 parts by weight based on about 100 parts by weight of the mixed resin containing the styrene resin and the char-generating thermoplastic resin. In some embodiments, the expanded inorganic material may be added in an amount of about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments of the present invention, the amount of the expanded inorganic material can be in a range from about any of the foregoing amounts to about any other of the foregoing amounts.

When the expanded inorganic material is added in an amount within this range, the polystyrene beads can exhibit excellent balance between processibility and non flammability.

The core 10 may further include carbon fillers 12.

FIG. 2 is a schematic cross-sectional view of an expandable polystyrene bead in accordance with another embodiment of the invention. As shown, the expandable polystyrene bead of this embodiment includes a core 10 and a skin 20 surrounding a surface of the core, wherein the core 10 includes expanded inorganic material 11 and a carbon filler 12 dispersed in a mixed resin 13.

Examples of the carbon fillers 12 may include without limitation graphite, carbon black, carbon fibers, carbon nanotubes, and the like, and combinations thereof.

The carbon fillers 12 may be in the form of particles, fibers, tubes, flakes, amorphous shapes, and the like, and combinations thereof. In exemplary embodiments, the carbon filler 12 is prepared in the form of particles.

In one embodiment, the carbon fillers 12 may have an average particle diameter from about 0.1 μm to about 100 μm, for example about 1 μm to about 50 μm, and as another example about 1 μm to about 30 μm. Within this range, the carbon filler can facilitate maintenance of droplets of the resultant polymer.

In the present invention, the carbon fillers may be used in an amount of about 0.01 parts by weight to about 30 parts by weight, for example about 1 part by weight to about 20 parts by weight, and as another example about 1.5 parts by weight to about 10 parts by weight, based on about 100 parts by weight of the mixed resin containing the styrene resin and the char-generating thermoplastic resin. In some embodiments, the carbon fillers may be used in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or 30 parts by weight. Further, according to some embodiments of the present invention, the amount of the carbon fillers can be in a range from about any of the foregoing amounts to about any other of the foregoing amounts.

When the carbon fillers are used in an amount within this range, the polystyrene beads can exhibit excellent processibility and thermal insulation properties.

In one embodiment, the weight ratio of the expanded inorganic material to the carbon fillers can range from about 5:1 to about 50:1, for example from about 10:1 to about 30:1. Within this range, the polystyrene beads can exhibit excellent thermal insulation and non flammable properties.

Skin

The skin 20 is formed on an outer surface of the core 10.

The skin 20 may surround the entirety of the core or may discontinuously surround a portion of the core. In exemplary embodiments, the skin surrounds about 90% to about 100% of the surface area of the core.

The skin 20 may include a resin 21 having a glass transition temperature of about 120° C. or less, for example about 80° C. to about 120° C.

In one embodiment, the resin having a glass transition temperature of about 120° C. or less is a styrene resin. Examples of the resin may include without limitation general purpose polystyrene (GPPS) resins, high impact polystyrene (HIPS) resins, copolymers of styrene monomers and α-methylstyrene, acrylonitrile-butadiene-styrene copolymers (ABS), styrene-acrylonitrile copolymers (SAN), styrene-methyl methacrylate copolymers, blends of styrene resins and polymethyl methacrylate, and the like, and combinations thereof. In exemplary embodiments, general purpose polystyrenes (GPPS) and/or high impact polystyrene (HIPS) resins can be used.

In one embodiment, the resin 21 having a glass transition temperature of about 120° C. or less may have a weight average molecular weight of about 130,000 g/mol to about 300,000 g/mol. Within this range, the polystyrene beads can exhibit excellent mechanical properties in terms of foamability, compressive strength, flexural strength, and the like.

The expandable polystyrene beads may have an average particle diameter (D) of about 0.5 mm to about 5 mm.

The ratio of core radius R to skin thickness T may range from about 1:0.0001 to about 1:0.2. Within this range, the expandable polystyrene beads can exhibit excellent mechanical properties and allow easy formation.

In addition, the weight ratio of the core 10 to the skin 20 may range from about 1:0.035 to about 1:0.23. Within this range, the expandable polystyrene beads can exhibit excellent mechanical properties and allow easy formation.

The foaming agent may be impregnated into the core 10 and/or the skin 20.

The foaming agent is well known to those skilled in the art. Examples of the foaming agents may include without limitation C₃-C₆ hydrocarbons, such as propane, butane, isobutene, n-pentane, isopentane, neopentane, cyclopentane, hexane and cyclohexane; halogenated hydrocarbons, such as trichlorofluoromethane, dichlorofluoromethane, dichlorotetrafluoroethane, and the like, and combinations thereof. In exemplary embodiments, pentane can be used.

In the present invention, the foaming agent may be present in an amount of about 3 parts by weight to about 10 parts by weight based on about 100 parts by weight of the core. In some embodiments, the foaming agent may be used in an amount of about 3, 4, 5, 6, 7, 8, 9, or 10 parts by weight. Further, according to some embodiments of the present invention, the amount of the foaming agent can be in a range from about any of the foregoing amounts to about any other of the foregoing amounts.

When the foaming agent is present in an amount within the range, good processability can be ensured.

One or more additives can also be present in the core and/or skin. Examples of the additives may include without limitation antiblocking agents, nucleating agents, antioxidants, carbon particles, fillers, antistatic agents, plasticizers, pigments, dyes, heat stabilizers, UV absorbers, flame retardants, and the like. The additives may be used alone or in combination of two or more thereof.

The antiblocking agent may be optionally used to provide adhesion between particles upon foaming or to facilitate fusion between particles upon preparation of thermal insulation materials. For example, the antiblocking agent may be a copolymer of ethylene-vinyl acetate.

The nucleating agents may be polyethylene wax.

Examples of the flame retardants include without limitation phosphor flame retardants, such as tris(2,3-dibromopropyl) phosphate, triphenylphosphate, bisphenol A diphenyl phosphate, and the like, halogen flame retardants, such as hexabromocyclododecane, tribromophenyl allylether, and the like, and combinations thereof. In exemplary embodiments, bisphenol A diphenylphosphate is used.

Method for Preparing Expandable Polystyrene Beads

The present invention also relates to a method for preparing expandable polystyrene beads.

In one embodiment, the method includes: preparing a core including a styrene resin, a char-generating thermoplastic resin and expanded inorganic material; and forming a skin on a surface of the core by adding a monomer having a glass transition temperature of about 120° C. or less to the core for polymerization.

(1) Preparation of Core

In one embodiment, the core may be prepared by extruding a mixture of the styrene resin, the char-generating thermoplastic resin and the expanded inorganic material. For example, the core may be prepared by mixing about 3 parts by weight to about 50 parts by weight of the expanded inorganic material with about 100 parts by weight of a mixed resin, which includes about 90 wt % to about 99 wt % of the styrene resin and about 1 wt % to about 10 wt % of the char-generating thermoplastic resin, followed by extruding the mixture.

In another embodiment, the core may be prepared by adding carbon fillers to the mixture of the styrene resin, the char-generating thermoplastic resin and the expanded inorganic material, followed by extruding the mixture. For example, the core may be prepared by mixing about 3 to about 50 parts by weight of the expanded inorganic material and about 0.01 to about 30 parts by weight of the carbon fillers with about 100 parts by weight of the mixed resin, which includes about 90 wt % to about 99 wt % of the styrene resin and about 1 wt % to about 10 wt % of the char-generating thermoplastic resin, followed by extrusion.

The styrene resin may be in the form of pellets. In other words, any commercially available styrene resin pellets may be used without any separate styrene polymerization process, thereby providing an economically feasible and simple process. In one embodiment, the styrene resin pellets may have a weight average molecular weight of about 180,000 g/mol to about 300,000 g/mol.

In one embodiment, the styrene resin pellets may optionally include an additive such as nucleating agents, antioxidants, carbon particles, fillers, antistatic agents, plasticizers, pigments, dyes, thermal stabilizers, UV absorbers, flame retardants, and the like. These additives may be used alone or in combination of two or more thereof.

The first pellets containing the styrene resin may be mixed with the char-generating thermoplastic resin, the expanded inorganic material particles, and optionally the carbon fillers to prepare a mixed composition.

Conventionally, the expanded inorganic material is coated onto outer surfaces of foam particles or added upon polymerization. However, in the case where the expanded inorganic material is added upon polymerization, the amount of the expanded inorganic material cannot be increased due to flocculation or collapse of the particles. In the case where the expanded inorganic material is coated onto the outer surfaces of the foam particles, final molded articles may have low strength. Thus, according to the invention, the core includes the expanded inorganic material and the skin is free from the expanded inorganic material, thereby preventing not only flocculation or collapse of the particles but also decrease in strength of the final molded articles.

Further, the carbon fillers are included only in the core and are not present in the skin, thereby preventing flocculation or collapse of the particles.

Optionally, the mixed composition may further include typical additives, such as but not limited to antiblocking agents, nucleating agents, antioxidants, carbon particles, fillers, antistatic agents, plasticizers, pigments, dyes, heat stabilizers, UV absorbers, flame retardants, and the like. These additives may be used alone or in combination of two or more thereof.

The mixed composition obtained by mixing the styrene resin, the char-generating thermoplastic resin, the expanded inorganic material and optionally the carbon fillers is extruded by an extruder to form second pellets, that is, cores.

Although not particularly limited, the extruder may have a die plate hole diameter of about 0.7 mm to about 2.0 mm, for example about 0.7 mm to about 1.7 mm, and as another example about 1.0 mm to about 1.5 mm, to obtain a desired grade. The obtained second pellets can have a size of about 2 mm or less. As such, it is possible to obtain second pellets having a desired size at high yield through extrusion.

The extrusion temperature can be adjusted to about 130° C. to about 250° C., for example about 150° C. to about 200° C.

In the present invention, it is possible to increase the content of carbon particles and to obtain the desired size and grade at high yield without any separate screening step by extrusion before the introduction of the foaming agent. In addition, the present invention may prevent explosion due to gas introduction upon extrusion.

In a further embodiment, the core may be prepared by polymerizing the styrene monomer, the char-generating thermoplastic resin and the expanded inorganic material.

For example, the core may be prepared by mixing (a1) a styrene monomer, (a2) a char-generating thermoplastic resin, and (a3) expanded inorganic material to prepare a liquid dispersion, and polymerizing the liquid dispersion.

In one embodiment, the liquid dispersion is prepared by mixing about 65 wt % to about 95 wt % of the (a1) styrene monomer, about 1 wt % to about 10 wt % of the (a2) char-generating thermoplastic resin and about 3 wt % to about 30 wt % of the (a3) expanded inorganic material.

Here, the polymerization may be carried out by suspension polymerization.

Examples of the styrene monomer may include without limitation styrene, α-methyl styrene, p-methyl styrene, and the like. These may be used alone or in combination of two or more thereof. In exemplary embodiments, styrene can be used.

In some embodiments, the styrene monomer may be used together with other ethylene unsaturated monomers. Examples of ethylene unsaturated monomers may include without limitation alkyl styrene, divinylbenzene, acrylonitrile, diphenyl ether, α-methylstyrene, and the like, and combinations thereof. In one embodiment, the styrene monomer may be a mixture of about 80 wt % to about 100 wt % of styrene and about 0 to about 20 wt % of an ethylene type unsaturated monomer.

In some embodiments, the combination including the styrene monomer and the other ethylene unsaturated monomer may include the styrene monomer in an amount of about 80, 81, 82, 83, 84, 85, 86, 87, 88, 89, 90, 91, 92, 93, 94, 95, 96, 97, 98, 99, or 100 wt %. Further, according to some embodiments of the present invention, the amount of the styrene monomer can be in a range from about any of the foregoing amounts to about any other of the foregoing amounts.

In some embodiments, the combination including the styrene monomer and the other ethylene unsaturated monomer may include the other ethylene unsaturated monomer in an amount of 0 (the other ethylene unsaturated monomer is not present), about 0 (the other ethylene unsaturated monomer is present), 1, 2, 3, 4, 5, 6, 7, 8, 9, 10, 11, 12, 13, 14, 15, 16, 17, 18, 19, or 20 wt %. Further, according to some embodiments of the present invention, the amount of the other ethylene unsaturated monomer can be in a range from about any of the foregoing amounts to about any other of the foregoing amounts.

In a further embodiment, the core may be prepared by polymerizing the styrene monomer, the char-generating thermoplastic resin, the expanded inorganic material, and the carbon fillers.

For example, the method of preparing the core may include: mixing (a1) a styrene monomer, (a2) a char-generating thermoplastic resin, (a3) expanded inorganic material and (a4) carbon fillers to prepare a liquid dispersion, and polymerizing the liquid dispersion.

In some embodiments, the liquid dispersion may be prepared by mixing about 65 wt % to about 95 wt % of the (a1) styrene monomer, about 1 wt % to about 10 wt % of the (a2) char-generating thermoplastic resin, about 3 wt % to about 30 wt % of the (a3) expanded inorganic material, and (a4) about 0.01 wt % to about 30 wt % of the carbon fillers.

Here, the polymerization may be carried out by suspension polymerization.

The liquid dispersion may further include typical additives. The additives may include without limitation antiblocking agents, nucleating agents, antioxidants, carbon particles, fillers, antistatic agents, plasticizers, pigments, dyes, heat stabilizers, UV absorbers, flame retardants, and the like. These may be used alone or in combination of two or more thereof.

During suspension polymerization, typical aids, for example, peroxide initiators, suspension stabilizers, foaming agents, chain transfer agents, expansion aids, nucleating aids, and the like, and combinations thereof may be added. These aids may be contained in the liquid dispersion.

The antiblocking agent is optionally used to provide adhesion between particles upon foaming or to facilitate fusion between particles upon preparation of thermal insulation materials. For example, the antiblocking agent may be a copolymer of ethylene-vinyl acetate.

The nucleating agents may be polyethylene wax.

Examples of the flame retardants may include without limitation phosphor flame retardants, such as tris(2,3-dibromopropyl) phosphate, triphenylphosphate, bisphenol A diphenyl phosphate and the like, halogen flame retardants, such as hexabromocyclododecane, tribromophenyl allylether, and the like, and combinations thereof. In exemplary embodiments, bisphenol A diphenylphosphate can be used.

As the suspension stabilizer, an inorganic pickering dispersing agent, for example, magnesium pyrophosphate and/or calcium phosphate, can be advantageously used.

In this way, substantially round bead cores having a particle size of about 0.5 mm to about 3 mm can be prepared through polymerization.

(2) Formation of Skin

The skin (B) is formed by adding a monomer having a glass transition temperature of about 120° C. to the above core.

The monomer provided for formation of the skin may have a glass transition temperature of about 120° C. or less, for example from about 80° C. to about 120° C. In one embodiment, the monomer for second polymerization may be styrene, α-methyl styrene, or a combination thereof. In exemplary embodiments, styrene is used.

In one embodiment, the skin is prepared by adding the monomer having a glass transition temperature of about 120° C. or less and an initiator to the core to prepare a liquid dispersion, followed by polymerization of the liquid dispersion.

The monomer having a glass transition temperature of about 120° C. or less may be added in an amount of about 5 parts by weight to about 30 parts by weight, for example about 10 parts by weight to about 25 parts by weight, based on about 100 parts by weight of the core. In some embodiments, the monomer having a glass transition temperature of about 120° C. or less may be added in an amount of about 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the monomer having a glass transition temperature of about 120° C. or less can be in a range from about any of the foregoing amounts to about any other of the foregoing amounts.

Within this range, it is possible to ensure excellent properties in terms of non-flammability, insulation properties, compressive strength, and flexural strength.

In one embodiment, the liquid dispersion may be prepared by stirring about 0.001 to 1.0 parts by weight of sodium pyrophosphate (10 hydrate) Na₄P₂O₇.10H₂O and about 0.001 to 1.0 parts by weight of magnesium chloride (MgCl₂) in 100 parts by weight of deionized water.

An emulsifying agent may be further added to the liquid dispersion. The emulsifying agent may be any typical emulsifying agent and can include, for example, sodium benzoate (DSM Company), tricalcium phosphate (BUNDNHEIM C13-08), and the like.

Any typical additives may be further added during polymerization, or to the liquid dispersion. Examples of the additives may include without limitation antiblocking agents, nucleating agents, antioxidants, carbon particles, fillers, antistatic agents, plasticizers, pigments, dyes, heat stabilizers, UV absorbers, flame retardants, peroxide initiators, suspension stabilizers, chain transfer agents, expansion aids, and the like. These additives may be used alone or in combination of two or more thereof.

The foaming agent may be added before, during or after polymerization. In one embodiment, the foaming agent may be added to the liquid dispersion after preparation of the core. In another embodiment, the foaming agent may be added during polymerization. In a further embodiment, the foaming agent may be added after polymerization. Adding the foaming agent may be easily carried out by those skilled in the art.

The foaming agent may be added in an amount of about 3 parts by weight to about 10 parts by weight based on about 100 parts by weight of the mixed resin and the core. In some embodiments, the foaming agent may be added in an amount of about 3, 4, 5, 6, 7, 8, 9, or 10 parts by weight. Further, according to some embodiments of the present invention, the amount of the foaming agent may be added can be in a range from about any of the foregoing amounts to about any other of the foregoing amounts.

Within this range of the foaming agent, the polystyrene beads can have good processibility.

The expandable polystyrene prepared as above may have a desired grade at a yield of about 100%.

In one embodiment, the expandable polystyrene beads may have an average particle diameter of about 0.5 mm to about 5 mm.

The surfaces of the expandable polystyrene beads prepared by the method according to the invention can be composed of the resin having a glass transition temperature of 120° C. or less and the foaming agent, which is impregnated into the resin, and are free from the char-generating thermoplastic resin and the expanded inorganic material or the carbon fillers.

The present invention further provides non-flammable foam produced using the expandable polystyrene beads.

In one embodiment, the foam produced using the expandable polystyrene beads may have a total heat release (THR) of about 0.9 MJ/m² or less, as measured after heating a 50 mm thick sample at 50 kW/m² using a cone heater for 5 minutes in accordance with KS F ISO 5560-1, a compressive strength of about 19 N/cm² or more in accordance with KS M 3808, and a degree of fusion of about 20% to about 60%.

In another embodiment, the foam may have a heat release rate (HRR) of less than about 0.9 kW/m², for example about 0.3 to about 0.88 kW/m², as measured after heating a 550 mm thick sample at 50 kW/m² using a cone heater for 5 minutes in accordance with KS F ISO 5560-1.

In addition, the foam may have a thermal conductivity of about 0.033 W/m·K or less, and a compressive strength of about 19 to about 30 N/cm².

The foam of the invention may be used in the production of various products, such as but not limited to packaging materials for home appliances, boxes for agricultural and fishery products, thermal insulation materials for buildings, and the like. Further, the foam can exhibit desirable properties in terms of non-flammability, mechanical strength and thermal insulation, and thus may be suitably used as thermal insulation materials for buildings and as cores of sandwich panels manufactured by inserting a thermal insulation core between iron plates.

The present invention will be explained in more detail with reference to the following examples. These examples are provided for illustration only and are not to be in any way construed as limiting the present invention.

### Examples 1 to 4

### Core Extruded Expandable Polystyrene Beads

### Example 1

### (1) Preparation of Core

To 95 parts by weight of (a1) GPPS pellets (GP HR-2390P00, Cheil Industries, Co., Ltd.) having a weight average molecular weight of 270,000 g/mol, 5 parts by weight of (a2) polyphenylene ether (PX100F, MEP Co., Ltd.) as a char-generating thermoplastic resin is added, followed by mixing with 20 parts by weight of (B) expanded graphite particles (MPH503, ADT Co., Ltd.) having an average particle size of 297 μm and an expansion temperature of 300° C. to prepare a mixed composition. The mixed composition is extruded through a twin-screw extruder for pelletization.

### (2) Formation of Skin

In a reactor, 0.8 parts by weight of sodium pyrophosphate (10 hydrate) Na₄P₂O₇.10H₂O and 0.9 parts by weight of magnesium chloride are stirred in 100 parts by weight of deionized water. Then, 100 parts by weight of the extruded pellets (core) is added to the mixture and maintained at 60° C. 0.3 parts by weight of dicumyl peroxide as an initiator and 0.3 parts by weight of t-butylperoxybenzoate are dissolved in 15 parts by weight of a styrene monomer, followed by injecting into the reactor at a constant rate for about 30 minutes to keep the suspension system stable. Then, the suspension is heated to 125° C. Next, 8 parts by weight of pentane mixed gas is added to the mixture and maintained at 125° C. for 6 hours, thereby producing expandable polystyrene beads. After drying for 5 hours, the coated expandable polystyrene beads are placed in a plate molder and a steam pressure of 0.5 kg/cm² is applied thereto to obtain a desired foam molded article.

Subsequently, the molded article is dried in a desiccator at 50° C. for 24 hours and cut to prepare specimens for measuring physical properties.

### Example 2

Specimens are prepared in the same manner as in Example 1 except that the styrene monomer is added in an amount of 7.5 parts by weight in the preparation of the skin, instead of 15 parts by weight.

### Example 3

Specimens are prepared in the same manner as in Example 1 except that 1.5 parts by weight of graphite particles (S-249, TIMCAL Co., Ltd.) having an average particle size of 6 μm are further added in the preparation of the core.

### Example 4

Specimens are prepared in the same manner as in Example 3 except that the styrene monomer is added in an amount of 7.5 parts by weight in the preparation of the skin, instead of 15 parts by weight.

### Comparative Example 1

As in Example 3, after preparing pellets (core (A)), 0.8 parts by weight of sodium pyrophosphate (10 hydrate) Na₄P₂O₇.10H₂O and 0.9 parts by weight of magnesium chloride are stirred in 100 parts by weight of deionized water in a reactor. Then, 100 parts by weight of the extruded pellets (core (A)) is added to the mixture and heated to 125° C. Next, 8 parts by weight of pentane mixed gas is added to the mixture and maintained at 125° C. for 6 hours, thereby producing expandable polystyrene beads.

### Comparative Example 2

Specimens are prepared in the same manner as in Example 3 except that 100 parts by weight of (a1) GPPS pellets is used instead of the char-generating thermoplastic resin.

Methods for Measuring Physical Properties

(1) Non-flammability: Non-flammability is evaluated in accordance with KS F ISO 5660-1 for testing incombustibility of internal finish materials and structure for buildings. A specimen is heated for 5 minutes, followed by testing to evaluate the total heat release (THR, MJ/m²), heat release rate (HRR, kW/m²), and cracking.

(2) Thermal conductivity (W/m·K): Thermal conductivity is measured by a method for measuring thermal conductivity of heat retention materials as prescribed in KS L9016, in which samples have a specific gravity of 30 kg/m³.

(3) Compressive strength (N/cm²): Compressive strength is measured by a method for measuring compressive strength of expandable polystyrene heat retention materials as prescribed in KS M 3808, in which samples have a specific gravity 30 kg/m³.

(4) Flexural strength (N/cm²): Flexural strength is measured by a method for measuring flexural strength of expandable polystyrene heat retention materials as prescribed in KS M 3808 in which samples have a specific gravity of 30 kg/m³.

(5) Degree of fusion (%): A percentage of the number of beads of which skin layer is invisible to the total number of beads of the cross-section of the foam molded article is calculated.

TABLE 1

| | | | Example | | | | Comparative Example | |
|---|---|---|---|---|---|---|---|---|
| | | | 1 | 2 | 3 | 4 | 1 | 2 |
| Core | Mixed | PS | 95 | 95 | 95 | 95 | 95 | 100 |
| | resin | Char- | 5 | 5 | 5 | 5 | 5 | — |
| | | generating | | | | | | |
| | | resin | | | | | | |

| | | | | | | |
|---|---|---|---|---|---|---|
| Expanded inorganic | 20 | 20 | 20 | 20 | 20 | 20 |
| material particles | | | | | | |
| Carbon filler | — | — | 1.5 | 1.5 | 1.5 | 1.5 |

| The amount of monomer in | | 15 | 7.5 | 15 | 7.5 | 0 | 15 |
|---|---|---|---|---|---|---|---|
| formation of skin | | | | | | (no skin) | |
| (parts by weight) | | | | | | | |
| Non | Peak-HRR | 2.19 | 2.20 | 2.18 | 2.17 | 2.18 | 2.18 |
| flammability | THR | 0.87 | 0.86 | 0.88 | 0.84 | 0.90 | 0.92 |
| | Outer appearance | No | No | No | No | No | Cracking |
| | | cracking | cracking | cracking | cracking | cracking | |

| | | | | | | |
|---|---|---|---|---|---|---|
| Thermal conductivity | 0.032 | 0.033 | 0.032 | 0.031 | 0.033 | 0.032 |
| Compressive strength | 19.5 | 19.3 | 19.6 | 19.2 | 17.7 | 18.2 |
| Flexural strength | 38.3 | 38.1 | 38.2 | 37.9 | 37.2 | 36.8 |
| Degree of fusion (%) | 35 | 23 | 37 | 31 | 5 | 35 |

As shown in Table 1, the specimens of Examples 1 to 4 have improved mechanical strength by fusion, such as flexural strength and compressive strength, as compared to the specimens of the comparative examples. In Comparative Example 1 wherein the skin is not formed, the specimens have considerably deteriorated compressive strength and flexural strength, and low degree of fusion. Further, in Comparative Example 2 wherein the mixed resin did not contain the char-generating thermoplastic resin, the specimens have insulating properties but underwent cracking after burning, thereby providing undesirable non-flammability.

### Examples 5-8

### Core-Polymerized Expandable Polystyrene Beads

### Example 5

### (1) First Polymerization-Preparation of Core

In a dissolving furnace, 82 parts by weight of a styrene monomer, 3 parts by weight of polyphenylene ether (PX100F, MEP Co., Ltd.), 15 parts by weight of expanded graphite particles (MPH803, ADT Co., Ltd.) having an average particle size of 180 μm or more, 0.3 parts by weight of benzoyl peroxide as an initiator, 0.1 parts by weight of t-butylperoxybenzoate, 0.55 parts by weight of hexabromocyclododecane, and 0.01 parts by weight of sodium alkylbenzene sulfonate are stirred for 60 minutes. Then, 100 parts by weight of deionized water and 0.3 parts by weight of tricalcium phosphate as a liquid dispersion are added to a 100 L reactor, and stirred for 30 minutes. The resultant organic phase is mixed with the mixture in the 100 L reactor. Then, the prepared suspension is rapidly heated to 90° C. and maintained at 90° C. for 4 hours, thereby preparing a first polymerized product.

### (2) Second Polymerization-Formation of Skin

In a reactor, 0.8 parts by weight of sodium pyrophosphate (10 hydrate) Na₄P₂O₇.10H₂O and 0.9 parts by weight of magnesium chloride (MgCl2) are stirred in 100 parts by weight of deionized water. Then, 100 parts by weight of the core prepared by the first polymerization is added to the mixture and maintained at 60° C. 0.3 parts by weight of dicumyl peroxide as an initiator and 0.3 parts by weight of t-butylperoxybenzoate are dissolved in 15 parts by weight of a styrene monomer, followed by stirring at a constant rate for about 30 minutes to keep the suspension system stable. Then, the suspension is heated to 125° C. Next, 8 parts by weight of pentane mixed gas is added to the mixture and maintained at 125° C. for 6 hours, thereby producing expandable polystyrene beads. After drying for 5 hours, the coated expandable polystyrene beads are placed in a plate molder and a steam pressure of 0.5 kg/cm² is applied thereto to obtain a desired foam molded article.

Subsequently, the molded article is dried in a desiccator at 50° C. for 24 hours and cut to prepare specimens for measuring physical properties.

### Examples 6 and 7

Specimens are prepared in the same manner as in Example 5 except that the amount of the styrene monomer is changed in second polymerization.

### Example 8

Specimens are prepared in the same manner as in Example 5 except that graphite particles (S-249, TIMCAL Co., Ltd.) having an average particle size of 6 μm are further added in the following amount in the preparation of the core.

### Examples 9 and 10

Specimens are prepared in the same manner as in Example 8 except that the amount of the styrene monomer is changed in second polymerization.

### Comparative Example 3

As in Example 1, after preparing the core (A), 0.8 parts by weight of sodium pyrophosphate (10 hydrate) Na₄P₂O₇.10H₂O and 0.9 parts by weight of magnesium chloride (MgCl₂) are stirred in 100 parts by weight of deionized water in a reactor. Then, 100 parts by weight of the core (A) prepared as above is added to the mixture and heated to 125° C. Next, 8 parts by weight of pentane mixed gas is added to the mixture and maintained at 125° C. for 6 hours, thereby producing expandable polystyrene beads.

### Comparative Example 4

Specimens are prepared in the same manner as in Example 5 except that the char-generating thermoplastic resin is not used.

TABLE 2

| | | | | | | | | Comparative | |
|---|---|---|---|---|---|---|---|---|---|
| | | Example | | | | | | Example | |
| | | 5 | 6 | 7 | 8 | 9 | 10 | 3 | 4 |
| Styrene monomer | | 82 | 82 | 82 | 79 | 79 | 79 | 79 | 82 |
| Char-generating resin | | 3 | 3 | 3 | 3 | 3 | 3 | 3 | — |
| Expanded inorganic | | 15 | 15 | 15 | 15 | 15 | 15 | 15 | 15 |
| material particles | | | | | | | | | |
| Carbon fillers | | — | — | — | 3 | 3 | 3 | 3 | 3 |
| The amount of monomer in | | 15 | 7.5 | 7.5 | 15 | 10 | 7.5 | 0 | 15 |
| formation of skin | | | | | | | | | |
| (parts by weight) | | | | | | | | | |
| Non | Peak-HRR | 2.19 | 2.20 | 2.20 | 2.19 | 2.17 | 2.18 | 2.18 | 2.29 |
| flammability | THR | 0.87 | 0.86 | 0.86 | 0.89 | 0.86 | 0.83 | 0.90 | 0.99 |
| | Outer | No | No | No | No | No | No | No | Cracking |
| | appearance | cracking | cracking | cracking | cracking | cracking | cracking | cracking | |

| | | | | | | | | |
|---|---|---|---|---|---|---|---|---|
| Thermal conductivity | 0.032 | 0.033 | 0.033 | 0.032 | 0.031 | 0.031 | 0.031 | 0.034 |
| Compressive strength | 19.5 | 19.3 | 19.3 | 19.7 | 19.3 | 19.1 | 17.7 | 19.7 |
| Flexural strength | 38.3 | 38.1 | 38.1 | 38.2 | 38.1 | 37.9 | 37.2 | 37.4 |
| Degree of fusion (%) | 35 | 23 | 23 | 38 | 32 | 29 | 5 | 46 |

As shown in Table 2, the specimens of Examples 5 to 10 have improved mechanical strength by fusion, such as flexural strength and compressive strength, as compared to the specimens of the comparative examples. In Comparative Example 3 wherein the skin is not formed, the specimens have considerably deteriorated compressive strength and flexural strength, and low degree of fusion. Further, in Comparative Example 4 wherein the mixed resin did not contain the char-generating thermoplastic resin, the specimens are dispersed like dust instead of forming char after burning.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. Expandable polystyrene beads, comprising:
a core comprising a styrene resin, a char-generating thermoplastic resin, and expanded inorganic material; and
a skin formed on a surface of the core and comprising a resin having a glass transition temperature of about 120° C. or less,
wherein the core, the skin, or both includes a foaming agent.

2. The expandable polystyrene beads according to claim 1, wherein the core further comprises carbon fillers.

3. The expandable polystyrene beads according to claim 2, wherein the carbon fillers comprise graphite, carbon black, carbon fibers, carbon nanotubes, or a combination thereof.

4. The expandable polystyrene beads according to claim 2, wherein the carbon fillers have an average particle diameter of about 0.1 μm to about 100 μm.

5. The expandable polystyrene beads according to claim 2, wherein the skin is free from the expanded inorganic material, the carbon fillers, or both.

6. The expandable polystyrene beads according to claim 1, wherein the skin surrounds a portion or the entirety of a surface of the core.

7. The expandable polystyrene beads according to claim 1, wherein surfaces of the expandable polystyrene beads are composed of the resin having a glass transition temperature of about 120° C. or less and a foaming agent impregnated into the resin, and are free from the char-generating thermoplastic resin and the expanded inorganic material.

8. The expandable polystyrene beads according to claim 1, wherein the styrene resin and the char-generating thermoplastic resin of the core are present in a ratio of about 90 to about 99 wt %:about 1 to about 10 wt %.

9. The expandable polystyrene beads according to claim 1, wherein the styrene resin has a weight average molecular weight of about 180,000 g/mol to about 300,000 g/mol.

10. The expandable polystyrene beads according to claim 1, wherein the char-generating thermoplastic resin has an oxygen bond, an aromatic group, or a combination thereof in a backbone thereof.

11. The expandable polystyrene beads according to claim 1, wherein the char-generating thermoplastic resin comprises polycarbonate, polyphenylene ether, polyurethane, polyphenylene sulfide, polyester, polyimide resin or a combination thereof.

12. The expandable polystyrene beads according to claim 1, wherein the expanded inorganic material comprises expanded graphite, silicate, perlite, white sand or a combination thereof.

13. The expandable polystyrene beads according to claim 1, wherein the expanded inorganic material has an average particle diameter of about 170 μm to about 1,000 μm, and an expansion temperature of about 150° C. or more.

14. The expandable polystyrene beads according to claim 1, wherein the resin having a glass transition temperature of about 120° C. or less comprises general purpose polystyrene (GPPS) resins, high impact polystyrene (HIPS) resins, acrylonitrile-butadiene-styrene (ABS) copolymers, styrene-acrylonitrile (SAN) copolymers, styrene-methyl methacrylate copolymers, or a combination thereof.

15. The expandable polystyrene beads according to claim 1, further comprising:
at least one additive selected from the group consisting of antiblocking agents, nucleating agents, antioxidants, carbon particles, fillers, antistatic agents, plasticizers, pigments, dyes, heat stabilizers, UV absorbers, flame retardants, and combinations thereof.

16. The expandable polystyrene beads according to claim 1, wherein a ratio of core radius to skin thickness ranges from about 1:0.0001 to about 1:0.2.

17. The expandable polystyrene beads according to claim 1, wherein the expandable polystyrene beads have an average particle diameter of about 0.5 mm to about 5 mm.

18. The expandable polystyrene beads according to claim 1, wherein a weight ratio of the core to the skin ranges from about 1:0.035 to about 1:0.23.

19. A non-flammable polystyrene foam formed from the expandable polystyrene beads according to claim 1, wherein the foam has a total heat release (THR) of about 0.9 MJ/m² or less, as measured after heating a 50 mm thick sample at 50 kW/m² using a cone heater for 5 minutes in accordance with KS F ISO 5560-1, a compressive strength of about 19 N/cm² or more in accordance with KS M 3808, and a degree of fusion of about 20% to about 60%

20. A method for preparing non-flammable expandable polystyrene beads, comprising:
preparing a core comprising a styrene resin, a char-generating thermoplastic resin and expanded inorganic material; and
forming a skin on a surface of the core through polymerization by adding a monomer having a glass transition temperature of about 120° C. or less to the core.

21. The method according to claim 20, wherein the core is prepared by extruding a mixture of the styrene resin, the char-generating thermoplastic resin and the expanded inorganic material.

22. The method according to claim 20, wherein the core is prepared by adding carbon fillers to a mixture of the styrene resin, the char-generating thermoplastic resin and the expanded inorganic material, followed by extruding the mixture.

23. The method according to claim 20, wherein the core is prepared by polymerizing a mixture of the styrene monomer, the char-generating thermoplastic resin and the expanded inorganic material.

24. The method according to claim 20, wherein the core is prepared by polymerizing a mixture of the styrene monomer, the char-generating thermoplastic resin and the expanded inorganic material, and carbon fillers.

25. The method according to claim 20, wherein the step of forming a skin comprises adding about 5 parts by weight to about 30 parts by weight of a monomer having a glass transition temperature of about 120° C. or less based on about 100 parts by weight of the core for polymerization.

26. The method according to claim 20, wherein the step of forming a skin comprises adding a foaming agent before, during or after polymerization.

27. The method according to claim 20, wherein the step of forming a skin comprises adding at least one additive selected from the group consisting of antiblocking agents, nucleating agents, antioxidants, carbon particles, fillers, antistatic agents, plasticizers, pigments, dyes, heat stabilizers, UV absorbers, flame retardants, peroxide initiators, suspension stabilizers, foaming agents, chain transfer agents, expansion aids, and combinations thereof when polymerizing by adding the monomer having a glass transition temperature of about 120° C. or less.
